(19) United States
(12) Patent Application Publication
(10) Pub. No.: US 2023/0244944 A1
(43) Pub. Date: Aug. 3, 2023

(54) SEARCH METHOD AND APPARATUS

(71) Applicant: BEIJING SOGOU TECHNOLOGY DEVELOPMENT CO., LTD., Beijing (CN)

(72) Inventors: Tao Wei, Beijing (CN); Xudong Rao, Beijing (CN)

(73) Assignee: BEIJING SOGOU TECHNOLOGY DEVELOPMENT CO., LTD., Beijing (CN)

(21) Appl. No.: 18/129,523

(22) Filed: Mar. 31, 2023

Related U.S. Application Data
(63) Continuation of application No. PCT/CN2021/102565, filed on Jun. 25, 2021.

(30) Foreign Application Priority Data
Dec. 3, 2020 (CN) 202011396358.2

(51) Int. Cl. G06N 3/084

(52) U.S. Cl. CPC G06N 3/084

(57) ABSTRACT

The present disclosure relates to a search method and apparatus. The method includes: obtaining network construction information corresponding to a target task, the network construction information including: search space information, sample data, and a search indicator; constructing a supernetwork based on the search space information and training the supernetwork based on the sample data, the supernetwork including a plurality of sub-networks; and searching a sub-network from the trained supernetwork based on the search indicator, to obtain a target network for performing the target task.

### RELATED APPLICATION

This application is a continuation application of PCT Patent Application No. PCT/CN2021/102565, filed on Jun. 25, 2021, which claims priority to Chinese Patent Application No. 202011396358.2, entitled “SEARCH METHOD AND APPARATUS AND ELECTRONIC DEVICE” filed with the State Intellectual Property Office on Dec. 3, 2020, wherein the content of the of the above-referenced applications is incorporated herein by reference in its entirety.

### FIELD OF THE TECHNOLOGY

This disclosure relates to the field of data processing technologies, and in particular, to a search method and apparatus and an electronic device.

### BACKGROUND OF THE DISCLOSURE

One of major scientific and technological research tasks currently facing mankind is to reveal working mechanisms of brains and the essence of human intelligence and create artificial intelligence systems capable of completing human intelligence activities. Neural networks are used to study functions of brains based on structures of nervous systems of brains and study information processing capabilities and dynamic behaviors of simple neurons of human brains. After decades of development, neural networks can now provide satisfactory solutions to some difficult problems that have plagued computer science and symbol processing for a long time, and are widely used in many fields such as image recognition, pattern recognition, automatic control, signal processing, auxiliary decision-making, and artificial intelligence.

Image recognition algorithms based on neural network design can obtain high accuracy, but at the same time, require higher computing power, making it very difficult to apply the algorithms to mobile terminals with limited computing power. To achieve balance between computing power and algorithm accuracy, people manually design some lightweight network structures, making it possible to run high-precision image recognition algorithms on mobile terminals. However, it is extremely difficult to manually design networks, which needs to take a lot of manpower, material resources, and time.

### SUMMARY

Embodiments of the present disclosure provide a search method to quickly construct a network while adapting to a task.

Correspondingly, the embodiments of the present disclosure also provide a search apparatus and an electronic device, so as to ensure the implementation and application of the above method.

To address the above problems, an embodiment of the present disclosure discloses a search method, specifically including: obtaining network construction information corresponding to a target task, the network construction information including: search space information, sample data, and a search indicator; constructing a supernetwork based on the search space information and training the supernetwork based on the sample data, the supernetwork including a plurality of sub-networks; and searching a sub-network from the trained supernetwork based on the search indicator, to obtain a target network for performing the target task.

Another embodiment of the present disclosure further discloses a search apparatus, including a memory operable to store computer-readable instructions and a processor circuitry operable to read the computer-readable instructions. When executing the computer-readable instructions, the processor circuitry is configured to: obtain network construction information corresponding to a target task, the network construction information including search space information, sample data, and a search indicator; construct a supernetwork based on the search space information and train the supernetwork based on the sample data, the supernetwork including a plurality of sub-networks; and search a sub-network from the trained supernetwork based on the search indicator, to obtain a target network for performing the target task.

Another embodiment of the present disclosure further discloses non-transitory machine-readable media, having instructions stored on the machine-readable media. The instructions are configured to, when executed, cause a machine to: obtain network construction information corresponding to a target task, the network construction information including search space information, sample data, and a search indicator; construct a supernetwork based on the search space information and train the supernetwork based on the sample data, the supernetwork including a plurality of sub-networks; and search a sub-network from the trained supernetwork based on the search indicator, to obtain a target network for performing the target task.

The embodiments of the present disclosure include the following advantages:

In the embodiments of the present disclosure, network construction information corresponding to a target task may be obtained, the network construction information including: search space information, sample data, and a search indicator; then, a supernetwork may be constructed based on the search space information and the supernetwork may be trained based on the sample data; and a sub-network may be searched for from the trained supernetwork based on the search indicator, to obtain a target network for performing the target task. Compared with the related technology that requires manual design of networks, this embodiment of this disclosure can adapt to a task and quickly construct a network.

The above description is only an overview of the technical solutions of the present disclosure, to better understand the technical means of the present disclosure for implementation according to the content of the specification. Besides, to make the above and other purposes, features, and advantages of the present disclosure more obvious and understandable, the following specifically cites the specific implementations of the present disclosure.

### BRIEF DESCRIPTION OF THE DRAWINGS

To describe the technical solutions in the embodiments of this disclosure or in the prior art more clearly, the following briefly introduces the accompanying drawings for describing the embodiments or the prior art. Apparently, the accompanying drawings in the following description show merely some embodiments of this disclosure, and a person of ordinary skill in the art may still derive other drawings from the accompanying drawings without creative efforts.

FIG. 1 is a flowchart of a search method according to an embodiment of this disclosure;

FIG. 2A is a flowchart of a search method according to an embodiment of the present disclosure;

FIG. 2B is a schematic structural diagram of a supernetwork according to an embodiment of this disclosure;

FIG. 3 is a flowchart of a search method according to another embodiment of the present disclosure;

FIG. 4 is a structural block diagram of an electronic apparatus according to an embodiment of this disclosure;

FIG. 5 is a structural block diagram of an electronic apparatus according to an embodiment of this disclosure;

FIG. 6 is a structural block diagram of an electronic device for searching according to an exemplary embodiment of this disclosure; and

FIG. 7 is a schematic structural diagram of an electronic device for searching according to another exemplary embodiment of this disclosure.

### DESCRIPTION OF EMBODIMENTS

To make the objectives, features, and advantages of the present disclosure more obvious and comprehensible, the present disclosure is further described in detail below with reference to the accompanying drawings and specific implementations.

The embodiments of the present disclosure provide a network search platform/network search service, the network search platform/network search service can execute steps of a search method in the embodiments of the present disclosure, and rapidly construct a network while adapting to a task. Furthermore, when a user needs to construct a network that can be used to perform a specific task, the user can obtain the network through search based on the network search platform/network search service without manually designing the network.

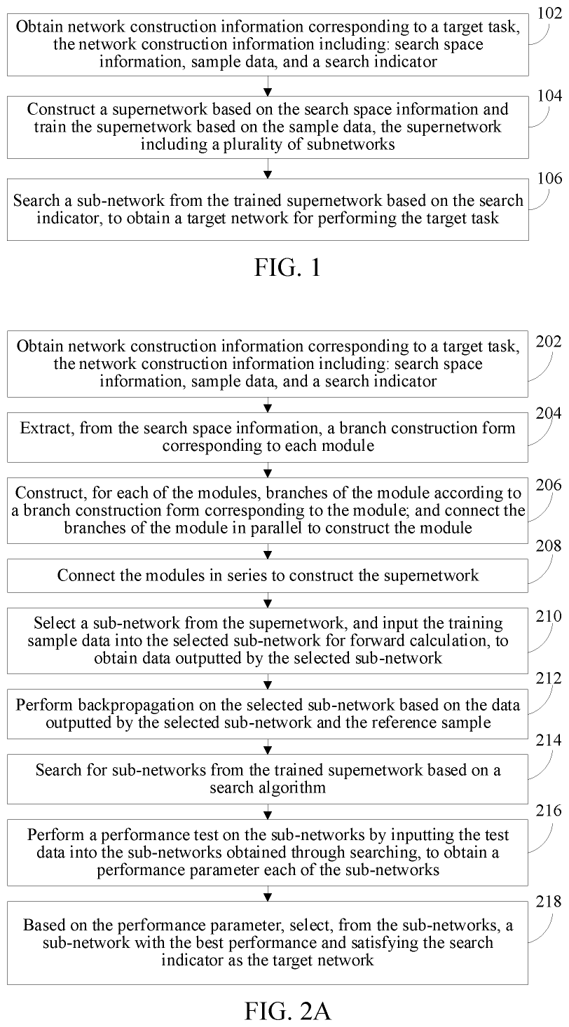

FIG. 1 is a flowchart of a search method according to an embodiment of the present disclosure, which may specifically include the following steps:

Step 102: Obtain network construction information corresponding to a target task, the network construction information including: search space information, sample data, and a search indicator.

In this embodiment of the present disclosure, a task that a user needs to perform may be referred to as the target task such as image recognition, image classification, image segmentation, and the like. A network that the user needs to construct to perform the target task is referred to as the target network. In an example, the target network may be a neural network.

In an example of the present disclosure, when a user needs to use a network search platform/network search service to search for a target network for performing the target task, the network construction information corresponding to the target task can be inputted into the network search platform/network search service. Furthermore, the network search platform/network search service may obtain the network construction information corresponding to the target task inputted by the user, and the network construction information may be information used to construct the target network. In an example, the network construction information may include: search space information, sample data, and a search indicator. The search space information may be information used to construct the supernetwork, and the supernetwork may be a network that is over and above an existing network. The sample data may be used to train the supernetwork. The search indicator may include a performance indicator of the target network and can be used to search for the target network from the supernetwork.

In an example of the present disclosure, the network search platform/network search service can provide network construction information for various tasks. When a user needs to use the network search platform/network search service to search for the target network for performing the target task, the user can select the network construction information corresponding to the target task in the network search platform/network search service; and then the network search platform/network search service can obtain the network construction information that corresponds to the target task and that is selected by the user.

Step 104: Construct a supernetwork based on the search space information and train the supernetwork based on the sample data, the supernetwork including a plurality of sub-networks.

Step 106: Search a sub-network from the trained supernetwork based on the search indicator, to obtain a target network for performing the target task.

In this embodiment of the present disclosure, after the network search platform obtains the search space information, the network search platform can construct the supernetwork according to the search space information, and train the supernetwork based on the sample data until a training end condition is satisfied, so that the trained supernetwork can be obtained.

The supernetwork may include a plurality of sub-networks, after the trained supernetwork is obtained, the trained supernetwork may be searched for, and a plurality of sub-networks may be found from the trained supernetwork. Then, the target network that satisfies a search indicator is selected from the found sub-networks. The trained supernetwork may be searched for by using various methods, such as a random search algorithm, an evolutionary search algorithm, and a reinforcement learning algorithm. This is not limited in this embodiment of the present disclosure.

Subsequently, the user can deploy the target network in a corresponding terminal device such as a mobile terminal, a CPU (Central Processing Unit, central processing unit), or a GPU (Graphics Processing Unit, graphics processing unit), and execute the target task in the terminal device with the target network deployed. For example, pictures are inputted into the target network of the terminal device, and the target network performs image recognition, image classification, image segmentation, and the like.

In conclusion, in this embodiment of the present disclosure, network construction information corresponding to a target task may be obtained, the network construction information including: search space information, sample data, and a search indicator; then, a supernetwork may be constructed based on the search space information and the supernetwork may be trained based on the sample data; and a sub-network may be searched for from the trained supernetwork based on the search indicator, to obtain a target network for performing the target task. Compared with the related technology that requires manual design of networks, this embodiment of this disclosure can adapt to a task and quickly construct a network.

The following describes how to construct the supernetwork, how to train the supernetwork, and how to search for the target network.

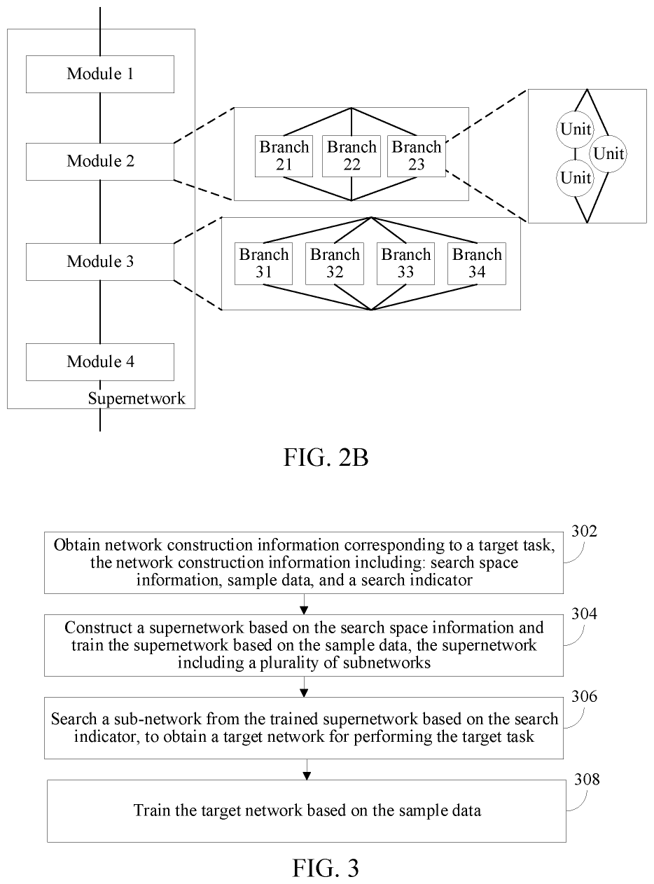

FIG. 2A is a flowchart of steps of a search method according to an embodiment of the present disclosure, which may specifically include the following steps:

Step 202: Obtain network construction information corresponding to a target task, the network construction information including: search space information, sample data, and a search indicator.

The search space information may include various information for constructing the supernetwork, such as definition of input data and output data of the supernetwork, definition of a loss function of the supernetwork, a number of modules forming the supernetwork, branch construction forms of branches in each module of the supernetwork, and unit construction information of units in each branch of the supernetwork, such as a type of an included convolution kernel, a network width of the supernetwork (a number of channels of a convolution layer), and a network depth of the supernetwork (a number of network layers). This is not limited in this embodiment of the present disclosure.

The sample data may include training data and test data, the training data is used for network training, and the test data is used for network testing.

The search indicator may include a plurality of performance indicators of the target network, such as calculation accuracy and a calculation speed. Certainly, the search indicator may also include other performance indicators of the target network, such as a memory occupied by calculation. This is not limited in this embodiment of the present disclosure.

Then, the supernetwork can be constructed based on the search space information, and reference can be made to step 204 to step 208:

Step 204: Extract, from the search space information, a branch construction form corresponding to each module.

Step 206: Construct, for each module, branches of the module according to a branch construction form corresponding to the module; and connect the branches of the module in parallel to construct the module.

Step 208: Connect modules in series to construct the supernetwork.

In this embodiment of the present disclosure, the supernetwork can include a plurality of modules connected in series, where the plurality of modules can include an input module, an output module, and at least one module between the input module and the output module. Each module between the input module and the output module can include at least one branch. When a module includes a plurality of branches, the module can be formed by connecting the plurality of branches in parallel. A branch may include at least one unit. When a branch includes a plurality of units, the branch may be formed by connecting the plurality of units in series, or may be formed by connecting the plurality of units in parallel, or may be formed by connecting the plurality of units in parallel and in series.

The definition of the input data of the supernetwork can be extracted from the search space information, and the input module of the supernetwork can be constructed based on the definition of the input data; and the definition of the output data of the supernetwork can be extracted from the search space information, and the output module for the supernetwork can be constructed based on the definition of the output data. Each module between the input module and the output module can be constructed as follows: first, the branch construction form of each branch in each module can be extracted from the search space information; and then for each module, each branch in this module can be constructed according to the branch construction form of the branch in this module. The unit construction information of each unit of each branch in the module can also be extracted from the search space information. Furthermore, in construction of each branch in the module, the branch can be constructed according to the branch construction form of the branch and the unit construction information of each unit included in the branch. Then, the branches included in the module are connected in parallel to construct the module.

After all the modules are constructed, all the modules can be connected in series to obtain the supernetwork. Refer to FIG. 2B. The supernetwork in FIG. 2B includes 4 modules, where a module 1 is an input module, a module 4 is an output module, a module 2 includes 3 branches, and a module 3 includes 4 branches. A branch of the module 2 can include 3 units.

In an example of the present disclosure, the connecting modules in series to construct the supernetwork includes: connecting the modules in series and connecting respective inputs and outputs of the modules to construct the supernetwork, to obtain networks of different depths. Whether to connect the respective inputs and outputs of the modules, and modules whose inputs and outputs are connected can be determined according to the target task. This is not limited in this embodiment of the present disclosure.

Training the supernetwork based on the sample data may refer to training the supernetwork by using training data in the sample data, which may include the following step 210 to step 212:

Step 210: Select a sub-network from the supernetwork, and input the training sample data into the selected sub-network for forward calculation, to obtain data outputted by the selected sub-network.

Step 212: Perform backpropagation on the selected sub-network based on the data outputted by the selected sub-network and the reference sample data.

In this embodiment of the present disclosure, the training data may include: training sample data and reference sample data corresponding to the training sample data, and one piece of training sample data and reference sample data corresponding to the training sample data may be referred to as a set of training data. The following uses a set of training data to illustrate the training of the supernetwork:

The set of training data can be inputted into the supernetwork, and the supernetwork can perform forward calculation based on the training sample data in the set of training data and output data. Then, backpropagation may be performed on the supernetwork according to the data outputted by the supernetwork and the reference sample data of the set of training data, that is, a weight of the supernetwork can be adjusted.

Assuming that an number of network widths of the supernetwork is set to C, each module has M (the number of branches included in each module)*C different options and the entire supernetwork has (M*C)N(a number of modules) options. Assuming N=20, M=3, and C=3, there are 920 options in total, and it can be seen that space of the supernetwork is very large. Therefore, in an embodiment of the present disclosure, a sub-network may be selected from the supernetwork, and then the selected sub-network may be trained.

The training sample data can be inputted into the selected sub-network for forward calculation, to obtain the data outputted by the selected sub-network; and then backpropagation is performed on the selected sub-network based on the data outputted by the selected sub-network and the reference sample data. The sub-network may refer to a network including at least one module with only some branches. For example, the sub-network of the supernetwork in FIG. 2B may include: a sub-network 1: (module 1-module 2-branch 1 of module 3-module 4); a sub-network 2: (module 1-module 2-branch 31 and branch 32 of module 3-module 4); a sub-network 3: (module 1-branch 21 of module 2-branch 31 of module 3-module 4); and a sub-network 4: (module 1-branch 21 and branch 22 of module 2-branch 31 of module 3-module 4), and the like. This can reduce the amount of calculation for supernetwork training, and further improve the efficiency of constructing the target network.

The definition of the loss function of the supernetwork in the search space information can be obtained, then a loss function result is calculated based on the data outputted by the selected sub-network, the reference sample data, and the definition of the loss function; and then backpropagation is performed on the selected sub-network based on the loss function result.

In an embodiment of the present disclosure, the supernetwork includes a plurality of modules connected in series, each module includes a plurality of branches connected in parallel, and the selecting a sub-network from the supernetwork includes: selecting a branch from each module of the supernetwork, and connecting, in series, branches selected from the modules, to form a sub-network. This can reduce the scale of the sub-network and further reduce the amount of calculation for supernetwork training, and further improve the efficiency of constructing the target network.

In an example, a branch may be selected from each module of the supernetwork according to a preset branch selection rule, and branches selected from the modules may be connected in series to form a sub-network. The preset branch selection rule can be set according to requirements, such as in-turn selection and random selection. This is not limited in this embodiment of the present disclosure.

After the training of the supernetwork is completed, the sub-network can be searched for from the trained supernetwork based on the search indicator, to obtain the target network for performing the target task. The following step 214 to step 218 can be included:

Step 214: Search for a sub-network from the trained supernetwork based on a search algorithm.

Step 216: Perform a performance test on the sub-network by inputting the test data into the sub-network obtained through search, to obtain a performance parameter of the sub-network.

Step 218: Based on the performance parameter of at least one found sub-network, select, from the at least one found sub-network, a sub-network with the best performance and satisfying the search indicator as the target network.

In this embodiment of the present disclosure, a search algorithm may be first used to search for a sub-network from the trained supernetwork; and then test data may be inputted into the sub-network. After the test data is inputted into the sub-network, on the one hand, the sub-network can calculate and output based on the test data; and on the other hand, the performance of the sub-network can be tested in a process of calculating based on the test data by the sub-network, to obtain the performance parameter corresponding to the network. The performance of the sub-network to be tested may correspond to the performance corresponding to the performance indicator in the search indicator; for example, if the search indicator includes the indicator of calculation accuracy and the indicator of calculation speed, the performance of the sub-network to be tested may include calculation accuracy and a calculation speed. Then, based on the performance parameter of at least one found sub-network, a sub-network with the best performance and satisfying the search indicator may be selected from the at least one found sub-network as the target network.

In an example, when the search algorithm is a random search algorithm, after the performance parameter of the sub-network is obtained, the performance parameter can be compared with the corresponding performance indicator in the search indicator. If the performance parameter of the sub-network can satisfy the corresponding performance indicator in the search index, the sub-network can be reserved; and then step 214 to step 216 are performed again. If the performance parameter of the sub-network cannot satisfy the corresponding performance indicator in the search indicator, the sub-network may be discarded, and then step 214 to step 216 are performed again. When a plurality of sub-networks (that is, reserved sub-networks) satisfy the corresponding performance parameter and the corresponding performance indicator in the search indicator, the optimal sub-network may be selected from these sub-networks as the target network. The optimal sub-network may be all sub-networks with the best overall performance, or may be one or more sub-networks with the best performance. Specifically, this may be set according to user requirements and is not limited in this embodiment of the present disclosure.

In another example, when the search algorithm is an evolutionary search algorithm, after a sub-network is obtained in the first search and the corresponding performance parameter is obtained, the sub-network obtained in the first search and the corresponding performance parameter can be reserved, and then step 214 to step 218 may be performed again. Starting from the second time, the process of performing step 214 may be: the trained supernetwork is searched for based on the reserved sub-network, to reorganize and/or mutate the reserved sub-network to generate a new sub-network. After the performance parameter of the new sub-network is determined, in a process of executing step 218, a performance parameter of a new sub-network currently generated can be compared with a performance parameter of a sub-network previously generated. If the performance parameter of the new sub-network currently generated is better than the performance parameter of the sub-network previously generated, the new sub-network currently generated and the corresponding performance parameter can be reserved, and then step 214 to step 218 are performed again. If the performance parameter of the new sub-network previously generated is better than the performance parameter of the sub-network currently generated, the new sub-network previously generated and the corresponding performance parameter can be reserved, and step 214 to step 218 are performed again, until the sub-network with the best performance and satisfying the search indicator is obtained.

In an embodiment of the present disclosure, a manner of searching for a sub-network from the supernetwork each time may be determined according to a search algorithm. This is not limited in this embodiment of the present disclosure.

In conclusion, in an embodiment of the present disclosure, in a process of constructing the supernetwork, the modules can be connected in series and the respective inputs and outputs of the modules can be connected to construct the supernetwork, to obtain networks of different depths and better satisfy task requirements of the user.

Second, in an embodiment of the present disclosure, in a process of training the supernetwork, the training sample data can be inputted into the supernetwork for forward calculation, to obtain the data outputted by the supernetwork; then a sub-network is selected from the supernetwork, and backpropagation is performed on the sub-network based on the data outputted by the supernetwork and reference sample data; thereby reducing the complexity of supernetwork training, improving the efficiency of supernetwork training, and further improving the efficiency of searching for the target network.

Again, in an embodiment of the present disclosure, a branch can be selected from each module of the supernetwork, and branches selected from the modules can be connected in series to form a sub-network. This can reduce the network parameter of the sub-network, to further reduce the complexity of supernetwork training, improve the efficiency of supernetwork training, and further improve the efficiency of searching for the target network.

In addition, in an embodiment of the present disclosure, a search algorithm can be used to search for a sub-network from the trained supernetwork; then, the performance of the sub-network is tested by inputting the test data into the found sub-network, to obtain a performance parameter of the found sub-network, and a sub-network with the best performance and satisfying the search indicator is selected as the target network from the found sub-networks based on the performance parameters of the found sub-networks, to find a sub-network with better performance as the target network, and improve the data processing precision of the target network.

FIG. 3 is a flowchart of a search method according to another embodiment of the present disclosure.

Step 302: Obtain network construction information corresponding to a target task, the network construction information including: search space information, sample data, and a search indicator.

Step 304: Construct a supernetwork based on the search space information and train the supernetwork based on the sample data, the supernetwork including a plurality of sub-networks.

Step 306: Search a sub-network from the trained supernetwork based on the search indicator, to obtain a target network for performing the target task.

Steps 302 to 306 are similar to step 202 to step 218 in the foregoing embodiment, and will not be described herein repeatedly.

Step 308: Train the target network based on the sample data.

In this embodiment of the present disclosure, after the target network is obtained, the target network can be further trained to improve the precision of the target network.

In an example of this disclosure, after finding the target network, a network search platform/network search service can output the target network. Then, a user can manually use sample data to train the target network; or the target network can be inputted to another platform and the another platform uses sample data to train the target network.

In another example of the present disclosure, after finding the target network, the network search platform/network search service can continue to use sample data to train the target network; and after completing the training of the target network, output the trained target network.

In conclusion, in an embodiment of the present disclosure, after the target network is obtained through search, the sample data may also be used to train the target network, so as to improve the precision of the target network.

In an embodiment of the present disclosure, after the target network is obtained, if the calculation speed of the target network needs to be increased, the target network can be accelerated, such as pruning and quantizing the target network. This is not limited in this embodiment of the present disclosure.

It should be noted that the foregoing method embodiments are expressed as a series of action combinations for the purpose of brief description, but a person skilled in the art should know that because some steps may be performed in other sequences or simultaneously according to the embodiments of this disclosure, the embodiments of this disclosure are not limited to a described action sequence. In addition, a person skilled in the art should also know that the embodiments described in this specification are all preferred embodiments; and therefore, an action and a module involved are not necessarily mandatory in the embodiments of this disclosure.

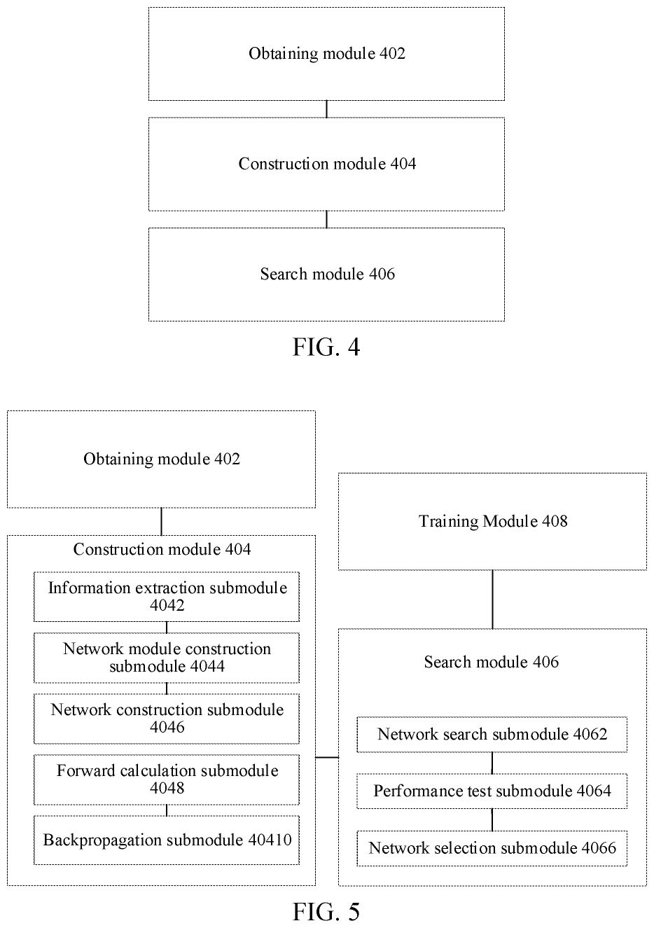

FIG. 4 is a structural block diagram of an electronic apparatus according to an embodiment of this disclosure, which may specifically include the following modules:

an obtaining module 402, configured to obtain network construction information corresponding to a target task, the network construction information including: search space information, sample data, and a search indicator;

a construction module 404, configured to construct a supernetwork based on the search space information and training the supernetwork based on the sample data, the supernetwork including a plurality of sub-networks; and

a search module 406, configured to search a sub-network from the trained supernetwork based on the search indicator, to obtain a target network for performing the target task.

Herein, the term module (and other similar terms such as unit, submodule, etc.) may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module. A module is configured to perform functions and achieve goals such as those described in this disclosure, and may work together with other related modules, programs, and components to achieve those functions and goals.

FIG. 5 is a structural block diagram of an electronic apparatus according to an embodiment of this disclosure.

In an embodiment of the present disclosure, the search space information includes: branch construction forms corresponding to a plurality of modules used to construct the supernetwork; and the construction module 404 includes:

an information extraction sub-module 4042, configured to extract, from the search space information, a branch construction form corresponding to each module;

a network module construction sub-module 4044, configured to construct, for each module, branches of the module according to a branch construction form corresponding to the module; and connect the branches of the module in parallel to construct the module; and

a network construction sub-module 4046, configured to connect modules in series to construct the supernetwork.

In an embodiment of the present disclosure, the network construction sub-module 4046 is configured to connect the modules in series and connect respective inputs and outputs of the modules to construct the supernetwork.

In an embodiment of the present disclosure, the sample data includes training data, the training data includes training sample data and reference sample data corresponding to the training sample data, and the construction module 404 includes:

a forward calculation sub-module 4048, configured to select a sub-network from the supernetwork, and input the training sample data into the selected sub-network for forward calculation, to obtain data outputted by the selected sub-network; and

a backpropagation sub-module 40410, configured to perform backpropagation on the selected sub-network based on the data outputted by the selected sub-network and the reference sample data.

In an embodiment of the present disclosure, the supernetwork includes a plurality of modules connected in series, each module includes a plurality of branches connected in parallel, and the forward calculation sub-module 4048 is configured to: select a branch from each module of the supernetwork, and connect, in series, branches selected from the modules, to form a sub-network.

In an embodiment of the present disclosure, the sample data includes test data, and the search module 406 includes:

a network search sub-module 4062, configured to search for a sub-network from the trained supernetwork based on a search algorithm;

a performance test sub-module 4064, configured to perform a performance test on the sub-network by inputting the test data into the sub-network obtained through search, to obtain a performance parameter of the sub-network; and

a network selection sub-module 4066, configured to: based on the performance parameter of at least one found sub-network, select, from the at least one found sub-network, a sub-network with the best performance and satisfying the search indicator as the target network.

In an embodiment of this disclosure, the apparatus further includes:

a training module 408, configured to train the target network based on the sample data.

In conclusion, in this embodiment of the present disclosure, network construction information corresponding to a target task may be obtained, the network construction information including: search space information, sample data, and a search indicator; then, a supernetwork may be constructed based on the search space information and the supernetwork may be trained based on the sample data; and a sub-network may be searched for from the trained supernetwork based on the search indicator, to obtain a target network for performing the target task. Compared with the related technology that requires manual design of networks, this embodiment of this disclosure can adapt to a task and quickly construct a network.

An apparatus embodiment is basically similar to a method embodiment, and therefore is described briefly. For related parts, refer to partial descriptions in the method embodiment.

FIG. 6 is a structural block diagram of an electronic device 600 for searching according to an exemplary embodiment. For example, the electronic device 600 may be a mobile phone, a computer, a digital broadcasting terminal, a messaging device, a game console, a tablet device, a medical device, a fitness device, a personal digital assistant, or the like.

Referring to FIG. 6, the electronic device 600 may include one or more of the following components: a processing component 602, a memory 604, a power supply component 606, a multimedia component 608, an audio component 610, an input/output (I/O) interface 612, a sensor component 614, and a communication component 616.

The processing component 602 usually controls the whole operation of the electronic device 600, such as operations associated with displaying, a phone call, data communication, a camera operation, and a recording operation. The processing component 602 may include one or more processors 620 to execute instructions, to complete all or some steps of the foregoing method. In addition, the processing component 602 may include one or more modules, to facilitate the interaction between the processing component 602 and other components. For example, the processing component 602 may include a multimedia module, to facilitate the interaction between the multimedia component 608 and the processing component 602.

The memory 604 is configured to store various types of data to support operations on the electronic device 600. Examples of the data include instructions, contact data, phonebook data, messages, pictures, videos, and the like of any application or method used to be operated on the electronic device 600. The memory 604 can be implemented by any type of volatile or non-volatile storage devices or a combination thereof, such as a static random access memory (SRAM), an electrically erasable programmable read only memory (EEPROM), an electrically erasable programmable read-only memory (EPROM), a programmable read-only memory (PROM), a read-only memory (ROM), a magnetic memory, a flash memory, a magnetic disc, or an optical disc.

The power supply component 606 provides power to various components of the electronic device 600. The power supply component 606 may include a power supply management system, one or more power supplies, and other components associated with generating, managing and allocating power for the electronic device 600.

The multimedia component 608 includes a screen providing an output interface between the electronic device 600 and a user. In some embodiments, the screen may include a liquid crystal display (LCD) and a touch panel (TP). If the screen includes a touch panel, the screen may be implemented as a touchscreen, to receive an input signal from the user. The touch panel includes one or more touch sensors to sense touching, sliding, and gestures on the touch panel. The touch sensor may not only sense the boundary of touching or sliding operations, but also detect duration and pressure related to the touching or sliding operations. In some embodiments, the multimedia component 608 includes a front camera and/or a rear camera. When the electronic device 600 is in an operation mode, such as a shoot mode or a video mode, the front camera and/or the rear camera may receive external multimedia data. Each front camera and rear camera may be a fixed optical lens system or have a focal length and an optical zooming capability.

The audio component 610 is configured to output and/or input an audio signal. For example, the audio component 610 includes a microphone (MIC), and when the electronic device 600 is in an operation mode, such as a call mode, a recording mode, and a voice identification mode, the microphone is configured to receive an external audio signal. The received audio signal may be further stored in the memory 604 or sent through the communication component 616. In some embodiments, the audio component 610 further includes a loudspeaker, configured to output an audio signal.

The I/O interface 612 provides an interface between the processing component 602 and an external interface module. The external interface module may be a keyboard, a click wheel, buttons, or the like. The buttons may include, but not limited to: a homepage button, a volume button, a start-up button, and a locking button.

The sensor component 614 includes one or more sensors, configured to provide status evaluation in each aspect to the electronic device 600. For example, the sensor component 614 may detect an opened/closed status of the electronic device 600, and relative positioning of the component. For example, the component is a display and a small keyboard of the electronic device 600. The sensor component 614 may further detect the position change of the electronic device 600 or one component of the electronic device 600, the existence or nonexistence of contact between the user and the electronic device 600, the azimuth or acceleration/deceleration of the electronic device 600, and the temperature change of the electronic device 600. The sensor component 614 may include a proximity sensor, configured to detect the existence of nearby objects without any physical contact. The sensor component 614 may further include an optical sensor, such as a CMOS or CCD image sensor, that is used in an imaging application. In some embodiments, the sensor component 614 may further include an acceleration sensor, a gyroscope sensor, a magnetic sensor, a pressure sensor, or a temperature sensor.

The communication component 616 is configured to facilitate communication in a wired or wireless manner between the electronic device 600 and other devices. The electronic device 600 may access a wireless network based on communication standards, such as Wi-Fi, 2G, or 3G, or a combination thereof. In an exemplary embodiment, the communication component 614 receives a broadcast signal or broadcast related information from an external broadcast management system via a broadcast channel. In an exemplary embodiment, the communication component 614 further includes a near field communication (NFC) module, to promote short range communication. For example, the NFC module may be implemented based on a radio frequency identification (RFID) technology, an infrared data association (IrDA) technology, an ultra wideband (UWB) technology, a Bluetooth (BT) technology, and other technologies.

In an exemplary embodiment, the electronic device 600 can be implemented as one or more application specific integrated circuit (ASIC), a digital signal processor (DSP), a digital signal processing device (DSPD), a programmable logic device (PLD), a field programmable gate array (FPGA), a controller, a micro-controller, a microprocessor or other electronic element, so as to perform the method.

In an exemplary embodiment, a non-transitory computer readable storage medium that includes an instruction, for example, the memory 604 that includes an instruction, is provided. The instruction may be executed by a processor 620 of the electronic device 600 to perform the method. For example, the non-transitory computer readable storage medium may be a ROM, a random access memory (RAM), a CD-ROM, a magnetic tape, a floppy disk, an optical data storage device, or the like.

A non-transitory computer-readable storage medium is provided. When an instruction in the storage medium is executed by the processor of the electronic device, the electronic device is enabled to execute a search method. The method includes: obtaining network construction information corresponding to a target task, the network construction information including: search space information, sample data, and a search indicator; constructing a supernetwork based on the search space information and training the supernetwork based on the sample data, the supernetwork including a plurality of sub-networks; and searching a sub-network from the trained supernetwork based on the search indicator, to obtain a target network for performing the target task.

In an implementation, the search space information includes: branch construction forms corresponding to a plurality of modules used to construct the supernetwork; and the constructing a supernetwork based on the search space information includes: extracting, from the search space information, a branch construction form corresponding to each module; constructing, for each module, branches of the module according to a branch construction form corresponding to the module; and connecting the branches of the module in parallel to construct the module; and connecting modules in series to construct the supernetwork.

In an implementation, the connecting modules in series to construct the supernetwork includes: connecting the modules in series and connecting respective inputs and outputs of the modules to construct the supernetwork.

In an implementation, the sample data includes training data, the training data includes training sample data and reference sample data corresponding to the training sample data, and the training the supernetwork based on the sample data includes: selecting a sub-network from the supernetwork, and inputting the training sample data into the selected sub-network for forward calculation, to obtain data outputted by the selected sub-network; and performing backpropagation on the selected sub-network based on the data outputted by the selected sub-network and the reference sample data.

In an implementation, the supernetwork includes a plurality of modules connected in series, each module includes a plurality of branches connected in parallel, and the selecting a sub-network from the supernetwork includes: selecting a branch from each module of the supernetwork, and connecting, in series, branches selected from the modules, to form a sub-network.

In an implementation, the sample data includes test data, and the searching a sub-network from the trained supernetwork based on the search indicator, to obtain a target network includes: searching for a sub-network from the trained supernetwork based on a search algorithm; performing a performance test on the sub-network by inputting the test data into the sub-network obtained through search, to obtain a performance parameter of the sub-network; and based on the performance parameter of at least one found sub-network, selecting, from the at least one found sub-network, a sub-network with the best performance and satisfying the search indicator as the target network.

In an implementation, the method further includes: training the target network based on the sample data.

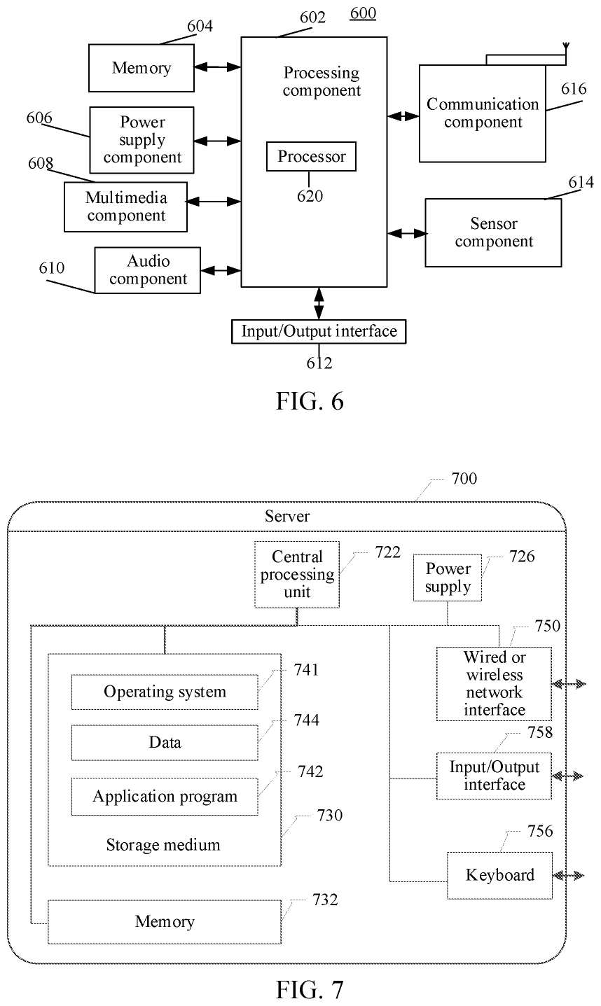

FIG. 7 is a schematic structural diagram of an electronic device 700 for searching according to another exemplary embodiment of this application. The electronic device 700 may be a server. The server may greatly differ as configuration or performance differs, may include one or more central processing units (CPU) 722 (for example, one or more processors), a memory 732, and one or more storage mediums 730 storing an application program 742 or data 744 (for example, one or more mass storage devices). The memory 732 and the storage medium 730 may be transient storage or persistent storage. The program stored in the storage medium 730 may include one or more modules (not marked in the figure), and each module may include a series of instruction operations of the server. Further, the CPU 722 may be configured to communicate with the storage medium 730, and execute, on the server, a series of instruction operations in the storage medium 730.

The server may further include one or more power supplies 726, one or more wired or wireless network interfaces 750, one or more input/output interfaces 758, one or more keyboards 756, and/or one or more operating systems 741, for example, Windows Server™, Mac OS X™, Unix™, Linux™, and FreeBSD™.

In an exemplary embodiment, the server is configured to be executed by the one or more central processing units 722, and the one or more programs include instructions for performing the following operations: obtaining network construction information corresponding to a target task, the network construction information including: search space information, sample data, and a search indicator; constructing a supernetwork based on the search space information and training the supernetwork based on the sample data, the supernetwork including a plurality of sub-networks; and searching a sub-network from the trained supernetwork based on the search indicator, to obtain a target network for performing the target task.

In an implementation, the search space information includes: branch construction forms corresponding to a plurality of modules used to construct the supernetwork; and the constructing a supernetwork based on the search space information includes: extracting, from the search space information, a branch construction form corresponding to each module; constructing, for each module, branches of the module according to a branch construction form corresponding to the module; and connecting the branches of the module in parallel to construct the module; and connecting modules in series to construct the supernetwork.

In an implementation, the connecting modules in series to construct the supernetwork includes: connecting the modules in series and connecting respective inputs and outputs of the modules to construct the supernetwork.

In an implementation, the sample data includes training data, the training data includes training sample data and reference sample data corresponding to the training sample data, and the training the supernetwork based on the sample data includes: selecting a sub-network from the supernetwork, and inputting the training sample data into the selected sub-network for forward calculation, to obtain data outputted by the selected sub-network; and performing backpropagation on the selected sub-network based on the data outputted by the selected sub-network and the reference sample data.

In an implementation, the supernetwork includes a plurality of modules connected in series, each module includes a plurality of branches connected in parallel, and the selecting a sub-network from the supernetwork includes: selecting a branch from each module of the supernetwork, and connecting, in series, branches selected from the modules, to form a sub-network.

In an implementation, the sample data includes test data, and the searching a sub-network from the trained supernetwork based on the search indicator, to obtain a target network includes: searching for a sub-network from the trained supernetwork based on a search algorithm; performing a performance test on the sub-network by inputting the test data into the sub-network obtained through search, to obtain a performance parameter of the sub-network; and based on the performance parameter of at least one found sub-network, selecting, from the at least one found sub-network, a sub-network with the best performance and satisfying the search indicator as the target network.

In an implementation, instructions for performing the following operation are also included: training the target network based on the sample data.

It should be noted that the embodiments in this specification are all described in a progressive manner. Description of each of the embodiments focuses on differences from other embodiments, and reference may be made to each other for the same or similar parts among respective embodiments.

The embodiments of this disclosure are described with reference to flowcharts and/or block diagrams of the method, the terminal device (system), and the computer program product in the embodiments of this disclosure. It should be understood that computer program instructions can implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing terminal device to generate a machine, so that an apparatus configured to implement functions specified in one or more procedures in the flowcharts and/or one or more blocks in the block diagrams is generated by using instructions executed by the general-purpose computer or the processor of another programmable data processing terminal device.

These computer program instructions may also be stored in a computer readable memory that can guide a computer or another programmable data processing terminal device to work in a specific manner, so that the instructions stored in the computer readable memory generate a product including an instruction apparatus, where the instruction apparatus implements functions specified in one or more procedures in the flowcharts and/or one or more blocks in the block diagrams.

These computer program instructions may also be loaded into a computer or another programmable data processing terminal device, so that a series of operation steps are performed on the computer or another programmable data processing terminal device to generate processing implemented by a computer, and instructions executed on the computer or another programmable data processing terminal device provide steps for implementing functions specified in one or more procedures in the flowcharts and/or one or more blocks in the block diagrams.

Although some exemplary embodiments of this disclosure have been described, persons skilled in the art can make changes and modifications to these embodiments once they learn the basic inventive concept. Therefore, the following claims are intended to be construed as to cover the exemplary embodiments and all changes and modifications falling within the scope of the embodiments of this disclosure.

Finally, it should be noted that in the specification, relational terms such as first and second are used only to differentiate an entity or operation from another entity or operation, and do not require or imply that any actual relationship or sequence exists between these entities or operations. Moreover, the terms “include”, “include”, and any variants thereof are intended to cover a non-exclusive inclusion. Therefore, in the context of a process, method, object, or device that includes a series of elements, the process, method, object, or device not only includes such elements, but also includes other elements not specified expressly, or may include inherent elements of the process, method, object, or device. Unless otherwise specified, an element limited by “include a/an . . . ” does not exclude other same elements existing in the process, the method, the article, or the apparatus that includes the element.

A search method and apparatus and an electronic device provided in this disclosure are described above in detail. Although the principles and implementations of the present disclosure are described by using specific examples in this specification, the descriptions of the foregoing embodiments are merely intended to help understand the method and the core idea of the method of the present disclosure. Meanwhile, a person skilled in the art may make modifications to the specific implementations and application range according to the idea of the present disclosure. In conclusion, the content of this specification should not be construed as a limitation to the present disclosure.

What is claimed is:

1. A search method, comprising:
obtaining network construction information corresponding to a target task, the network construction information comprising search space information, sample data, and a search indicator;
constructing a supernetwork based on the search space information and training the supernetwork based on the sample data, the supernetwork comprising a plurality of sub-networks; and
searching a sub-network from the trained supernetwork based on the search indicator, to obtain a target network for performing the target task.

2. The method according to claim 1, wherein the search space information comprises branch construction forms corresponding to a plurality of modules used to construct the supernetwork, and the constructing the supernetwork based on the search space information comprises:
extracting, from the search space information, a branch construction form corresponding to each of the modules;
constructing, for each of the modules, branches of the module according to a branch construction form corresponding to the module;
connecting the branches of the module in parallel to construct the module; and
connecting the modules in series to construct the supernetwork.

3. The method according to claim 2, wherein the connecting the modules in series to construct the supernetwork comprises:
connecting the modules in series and connecting respective inputs and outputs of the modules to construct the supernetwork.

4. The method according to claim 1, wherein the sample data comprises training data, the training data comprises training sample data and reference sample data corresponding to the training sample data, and the training the supernetwork based on the sample data comprises:
selecting a sub-network from the supernetwork, and inputting the training sample data into the selected sub-network for forward calculation, to obtain data outputted by the selected sub-network; and
performing backpropagation on the selected sub-network based on the data outputted by the selected sub-network and the reference sample data.

5. The method according to claim 4, wherein the supernetwork comprises a plurality of modules connected in series, each of the plurality of modules comprises a plurality of branches connected in parallel, and the selecting a sub-network from the supernetwork comprises:
selecting a branch from each of the plurality of modules of the supernetwork, and connecting, in series, branches selected from the modules to form a sub-network.

6. The method according to claim 1, wherein the sample data comprises test data, and the searching the sub-network from the trained supernetwork based on the search indicator to obtain the target network comprises:
searching for sub-networks from the trained supernetwork based on a search algorithm;
performing a performance test on the sub-networks by inputting the test data into the sub-networks obtained through search, to obtain a performance parameter for each of the sub-networks; and
selecting, from the sub-networks, a sub-network with a best performance and satisfying the search indicator as the target network based on the performance parameter.

7. The method according to claim 1, wherein the method further comprises:
training the target network based on the sample data.

8. A search apparatus, comprising:
a memory operable to store computer-readable instructions; and
a processor circuitry operable to read the computer-readable instructions, the processor circuitry when executing the computer-readable instructions is configured to:
obtain network construction information corresponding to a target task, the network construction information comprising search space information, sample data, and a search indicator;
construct a supernetwork based on the search space information and train the supernetwork based on the sample data, the supernetwork comprising a plurality of sub-networks; and
search a sub-network from the trained supernetwork based on the search indicator, to obtain a target network for performing the target task.

9. The apparatus according to claim 8, wherein the search space information comprises branch construction forms corresponding to a plurality of modules used to construct the supernetwork, and the processor circuitry is configured to:
extract, from the search space information, a branch construction form corresponding to each of the modules;
construct, for each of the modules, branches of the module according to a branch construction form corresponding to the module;
connect the branches of the module in parallel to construct the module; and
connect the modules in series to construct the supernetwork.

10. The apparatus according to claim 9, wherein the processor circuitry is configured to:
connect the modules in series and connect respective inputs and outputs of the modules to construct the supernetwork.

11. The apparatus according to claim 8, wherein the sample data comprises training data, the training data comprises training sample data and reference sample data corresponding to the training sample data, and the processor circuitry is configured to:
select a sub-network from the supernetwork, and input the training sample data into the selected sub-network for forward calculation, to obtain data outputted by the selected sub-network; and
perform backpropagation on the selected sub-network based on the data outputted by the selected sub-network and the reference sample data.

12. The apparatus according to claim 11, wherein the supernetwork comprises a plurality of modules connected in series, each of the plurality of modules comprises a plurality of branches connected in parallel, and the processor circuitry is configured to:
select a branch from each of the plurality of modules of the supernetwork, and connect, in series, branches selected from the modules to form a sub-network.

13. The apparatus according to claim 8, wherein the sample data comprises test data, and the processor circuitry is configured to:
search for sub-networks from the trained supernetwork based on a search algorithm;
perform a performance test on the sub-networks by inputting the test data into the sub-networks obtained through search, to obtain a performance parameter for each of the sub-networks; and
select, from the sub-networks, a sub-network with the best performance and satisfying the search indicator as the target network based on the performance parameter.

14. The apparatus according to claim 8, wherein the processor circuitry is further configured to:
train the target network based on the sample data.

15. A non-transitory machine-readable media, having instructions stored on the machine-readable media, the instructions configured to, when executed, cause a machine to:
obtain network construction information corresponding to a target task, the network construction information comprising search space information, sample data, and a search indicator;
construct a supernetwork based on the search space information and train the supernetwork based on the sample data, the supernetwork comprising a plurality of sub-networks; and
search a sub-network from the trained supernetwork based on the search indicator, to obtain a target network for performing the target task.

16. The non-transitory machine-readable media according to claim 15, wherein the search space information comprises branch construction forms corresponding to a plurality of modules used to construct the supernetwork, and the instructions are configured to cause the machine to:
extract, from the search space information, a branch construction form corresponding to each of the modules;
construct, for each of the modules, branches of the module according to a branch construction form corresponding to the module;
connect the branches of the module in parallel to construct the module; and
connect the modules in series to construct the supernetwork.

17. The non-transitory machine-readable media according to claim 16, wherein the instructions are configured to cause the machine to:
connect the modules in series and connect respective inputs and outputs of the modules to construct the supernetwork.

18. The non-transitory machine-readable media according to claim 15, wherein the sample data comprises training data, the training data comprises training sample data and reference sample data corresponding to the training sample data, and the instructions are configured to cause the machine to:
select a sub-network from the supernetwork, and input the training sample data into the selected sub-network for forward calculation, to obtain data outputted by the selected sub-network; and
perform backpropagation on the selected sub-network based on the data outputted by the selected sub-network and the reference sample data.

19. The non-transitory machine-readable media according to claim 15, wherein the supernetwork comprises a plurality of modules connected in series, each of the plurality of modules comprises a plurality of branches connected in parallel, and the instructions are configured to cause the machine to:
select a branch from each of the plurality of modules of the supernetwork, and connect, in series, branches selected from the modules to form a sub-network.

20. The non-transitory machine-readable media according to claim 15, wherein the sample data comprises test data, and the instructions are configured to cause the machine to:
search for sub-networks from the trained supernetwork based on a search algorithm;
perform a performance test on the sub-networks by inputting the test data into the sub-networks obtained through search, to obtain a performance parameter for each of the sub-networks; and
select, from the sub-networks, a sub-network with the best performance and satisfying the search indicator as the target network based on the performance parameter.
